(19) United States
(12) Patent Application Publication
(10) Pub. No.: US 2024/0286912 A1
(43) Pub. Date: Aug. 29, 2024

(54) METHOD FOR PRODUCING LITHIUM SULFATE AND TRANSITION METAL SULFATE

(71) Applicant: TODA KOGYO CORP., Hiroshima-shi, Hiroshima-ken (JP)

(72) Inventors: Tomohiro HONDA, Otake-shi, Hiroshima-ken (JP); Anyu ZHANG, Otake-shi, Hiroshima-ken (JP); Masayuki YOKOTA, Otake-shi, Hiroshima-ken (JP); Nobuyuki TAGAMI, Otake-shi, Hiroshima-ken (JP)

(21) Appl. No.: 18/578,865

(22) PCT Filed: Jul. 7, 2022
(86) PCT No.: PCT/JP2022/026912

§ 371 Date: Jan. 12, 2024

(30) Foreign Application Priority Data
Jul. 16, 2021 (JP) 2021-118344

(51) Int. Cl. C01D 15/06; C22B 3/44; H01M 10/54

(52) U.S. Cl. CPC C01D 15/06; C22B 3/44; H01M 10/54

(57) ABSTRACT

The present invention is to provide a means for efficiently and economically separating and recovering transition metals including nickel and cobalt, and lithium from an aqueous sulfate solution comprising the transition metal and lithium as major components.

The present invention is a process for producing lithium sulfate comprising:
a step of concentration-crystallization to an aqueous solution comprising at least lithium sulfate and a transition metal sulfate as main components so as to obtain a slurry comprising lithium sulfate as a solid content, and
a step of solid-liquid separation of the slurry obtained in the step of concentration-crystallization so as to separate lithium crystals and a crystallization mother liquor.

### TECHNICAL FIELD

The present invention relates to process for recovering transition metals and lithium contained in lithium- and transition metal-containing aqueous solutions generated in the recycling process of lithium ion secondary batteries and contained in lithium- and transition metal-containing aqueous solutions generated as by-products in the manufacturing and recycling processes of various battery materials, which are used as raw materials. Especially, the present invention relates to a process for recovering nickel and cobalt as transition metals.

### BACKGROUND ARTS

In recent years, in order to manufacture batteries with higher performance and higher energy density, the development and practical application of battery materials containing lithium and nickel as raw materials has been promoted. In such a situation where the production volume of battery materials is increasing, it becomes increasingly important to recover not only valuable transition metals such as nickel and cobalt but also lithium from waste fluid generated in the manufacturing process and used batteries and to recycle these elements.

In addition, unlike the extraction of nickel, cobalt, and lithium from ores, these recycled raw materials containing nickel, cobalt and lithium are limited in the types of elements that can be mixed as impurities. Therefore, it is most reasonable and efficient to reuse these recycled raw materials as a raw material for lithium-ion secondary battery materials and high-performance primary battery materials, which have strict standards of product quality.

The intermediates produced to synthesize lithium-ion secondary battery materials and high-performance primary battery materials are generally nickel-containing hydroxides called precursors. These intermediates are generally synthesized by a wet reaction process using nickel sulfate and sodium hydroxide as the main raw material. Therefore, the transition metal containing nickel as a main component is preferably recovered in the form of sulfate.

In addition, in the production of lithium composite oxides (active materials and intermediate products for battery materials) with a high nickel content as battery materials, instead of lithium carbonate which has been widely used in the past, lithium hydroxide which is more reactive is increasingly used as a raw material. Therefore, it is necessary to consider lithium recycling on the premise of producing lithium hydroxide.

As a method for producing lithium hydroxide, a method using lithium carbonate as an intermediate is known. In order to synthesize lithium carbonate, a method of reacting an aqueous solution containing lithium sulfate with sodium carbonate is known. Not only a large amount of sodium sulfate is generated as a by-product (if the lithium raw material is lithium chloride, the by-product is sodium chloride), but also dissolved lithium carbonate is mixed with the sodium sulfate solution so that any post-treatment to separate sodium and lithium is required. In view of requiring waste disposal and additional post-treatment processes, this method is not an economical production method.

Also, in order to produce lithium hydroxide from lithium carbonate, a method utilizing a reaction with calcium hydroxide is known. However, not only a large amount of calcium carbonate is generated as a by-product, but also calcium is also mixed into the lithium hydroxide so that a further purification step is required to obtain high-quality lithium hydroxide. Therefore, even if lithium carbonate can be synthesized by some economical method, lithium hydroxide cannot be synthesized economically.

For these reasons, the economic efficiency of the method for synthesizing lithium hydroxide via lithium carbonate is inevitably low, and further improvements are required.

On the other hand, a method of producing lithium hydroxide and sulfuric acid from lithium sulfate using an electrochemical membrane separation method is known. Electrochemical membrane separation methods are, for example, electrodialysis and compartmental electrolysis. By using these methods, it is possible to obtain an aqueous solution suitable for producing lithium hydroxide having a quality that can be used for the synthesis of lithium composite oxides. When a lithium sulfate aqueous solution is used as a raw material, sulfuric acid is produced at the same time as lithium hydroxide is produced.

However, since alkali metals cannot be separated by the electrochemical membrane separation method, in order to obtain high-grade lithium hydroxide, it is important that lithium sulfate with a sufficiently reduced content of alkali metals other than lithium is used as a raw material. More specifically, it is important not to contaminate lithium with sodium.

In addition, in the recycling process of lithium-ion secondary battery materials, it is common to dissolve transition metals and lithium into an aqueous solution by acid leaching. Since sulfuric acid is often used in acid leaching, sulfuric acid produced by electrochemical membrane separation methods using lithium sulfate as a raw material can be used in these acid leaching processes. Therefore, by using an electrochemical membrane separation method via lithium sulfate, it is possible not only to obtain high-grade lithium hydroxide, but also to obtain the sulfuric acid necessary for the acid leaching process, so that a highly efficient recycling process can be achieved that satisfies both reduction of wastes and quality assurance requirements.

Considering the entire recycling process from this perspective, it is most desirable that lithium is also recovered in the form of sulfate, that is, lithium sulfate.

However, the fact that the conventional technical level cannot realize such a process of directly obtaining transition metal sulfate and lithium sulfate is further described below with several examples.

### <Solvent Extraction Method>

The solvent extraction method is a technique for selectively transferring transition metals to an organic phase comprising an organic solvent, and regenerating the transition metal aqueous solution by extraction and back extraction operations by pH adjustment. As a lithium ion secondary battery material recycling using this technology, for example, Patent Documents 1 to 3 disclose a method comprising separating and recovering a transition metal from a sulfuric acid leaching solution, and finally reacting lithium sulfate with sodium carbonate to obtain lithium carbonate. A summary of the general flow of such technology is shown in FIG. 1.

Sodium hydroxide is generally used as a pH adjuster for performing extraction and back extraction. Therefore, a large amount of sodium sulfate is mixed in the residual liquid mainly comprising lithium sulfate after the transition metal is extracted. Lithium is recovered as lithium carbonate by reaction with sodium carbonate. The sodium sulfate solution remaining after the reaction contains dissolved lithium carbonate in an amount that cannot be ignored from the viewpoint of the purity of sodium sulfate.

Furthermore, unlike the case of adding sodium carbonate to relatively high-purity lithium sulfate to obtain lithium carbonate, when sodium carbonate is added to a lithium sulfate solution in which a large amount of sodium sulfate is dissolved together, the solubility of lithium sulfate lowers by a high concentration of sodium sulfate (lithium sulfate and sodium sulfate form a double salt). Thereby the lithium concentration in the raw material solution must be lowered and this is a factor in lowering the yield of lithium carbonate. In addition, the amount of sodium mixed in lithium carbonate also increases so that the quality of lithium carbonate obtained is lowered.

As shown in FIG. 1, the products obtained by this technique are lithium carbonate, mixed aqueous solution of sodium sulfate and lithium carbonate, in addition to the transition metal sulfate aqueous solution. Although the value of transition metal can be recovered, the recovered lithium has a value as lithium carbonate, so that a large amount of lithium-sodium mixed waste liquid needs to be treated. Therefore, this method cannot achieve an efficient recycling process as disclosed in the present invention.

### <Transition Metal Precipitation Method>

The transition metal precipitation method is a method of forming a precipitate by adjusting the pH of the transition metal contained in the acid leaching solution, and recovering the precipitate as a solid content by solid-liquid separation. Patent Document 4 discloses a method using lithium hydroxide as a precipitant (pH adjuster) in order to avoid mixing lithium and sodium. FIG. 2 shows a summary of the flow of this method.

Lithium hydroxide is used for the purpose of preventing sodium contamination in the precipitation process and is required in an amount equivalent to the amount of transition metals which are main components (lithium hydroxide is more costly than any alkaline such as sodium hydroxide), so that the economic burden is very high. In addition, in order to reuse the obtained solid content as a sulfate salt in applications such as precursor synthesis, it is necessary to re-dissolve the solid content with sulfuric acid, which lowers economic efficiency. Furthermore, precipitation of transition metals with lithium hydroxide tends to form fine particles so that a relatively large or special filtering apparatus is required and this is also a factor of impairing economic efficiency.

In addition, as a form of lithium recovery, lithium fluoride is obtained in an amount equivalent to the transition metals and lithium which are the main components contained in the acid leaching solution, but this substance has low solubility in water and is stable against heat. Therefore, it is greatly difficult to reconvert it to lithium hydroxide.

Therefore, even if it can be achieved that lithium is not mixed with sodium, it is not a preferable form of recovering transition metals and lithium, and it is not an economical and practical method for recovering the value of transition metals and lithium.

### <Direct Usage>

The direct utilization method incorporates an improved aspect of the transition metal precipitation method, and is a technique that directly utilizes the transition metal contained in the acid leaching solution for precursor synthesis. Patent Literature 5 discloses a method of using an aqueous lithium-containing transition metal sulfate solution for precursor synthesis after subjecting an acid leaching solution to a treatment for removing impurities. FIG. 3 shows a summary of the flow of this method.

Since acid leaching is directly used for precursor synthesis, the amount of sodium sulfate which is a neutralizing salt, can be the same as when synthesizing the precursor from a new material. In other words, it is possible to eliminate the generation of sodium sulfate accompanying the recycling of transition metals.

However, lithium is separated and recovered as lithium carbonate by reaction with sodium carbonate from the lithium-sodium mixed waste liquid after precursor synthesis. This is not an optimum form of recovering lithium as described above, and this is not an economical recycling process because it requires treatment of a large amount of the mixed wastewater of lithium and sodium.

In addition, a large amount of lithium sulfate dissolved in the transition metal aqueous solution affects the precursor synthesis process. That is, the solubility of the transition metal sulfate decreases due to the common ion effect, and the concentration of the transition metal sulfate aqueous solution used for precursor synthesis must be lower than those used in a conventional method, so that a productivity of the precursor decreases. Furthermore, there is a need to review the process parameters for precursor synthesis that have been optimized under the condition that the raw material solution is not contaminated with lithium sulfate. Such changes in process parameters are not desirable for raw materials of positive-electrode materials for lithium-ion batteries, to which strict quality control standards are applied. Even if changes in process parameters are allowed, in order to maintain the stability of raw material solution, it is necessary to use a certain constant percentage of recycled raw material, so that flexibility in operating the process is severely restricted.

Therefore, it is practically difficult to apply the direct utilization method to the existing precursor synthesis process with established quality control.

### CITATION LIST

### Patent Literature

Patent Document 1: Japanese Patent Application Laid-Open (KOKAI) 2016-186113
Patent Document 2: Korean Patent No. 10-1584120
Patent Document 3: Korean Patent No. 10-1563338
Patent Document 4: Japanese Patent Application Laid-Open (KOKAI) 2005-26088
Patent Document 5: WO 2017/091562 pamphlet

### SUMMARY OF INVENTION

### Technical Problem

As seen from the above description, there was no practical technique for efficiently and economically separating and recovering transition metals and lithium from aqueous sulfate solutions containing lithium and transition metals including nickel and cobalt as main components.

The present invention has been made in view of the above circumstances, and the object of the present invention is to provide a means for separating and recovering transition metals and lithium in a form suitable for reuse, so that reusing these valuable substances generated from the acid leaching process is significantly improved in the efficiency, economy and practicality.

### Solution to Problem

In order to solve the above-mentioned problems, as a result of intensive studies by the present inventors, it has been found that a method for directly obtaining high-purity lithium sulfate as a separated and recovered form of lithium in a recycling process using conventional technology has not been provided; and there is a serious problem that lithium and sodium are mixed in the process of separating and recovering the transition metal sulfate from the acid leaching solution.

As a result of further studies by the inventors, it has been found that a crystallization operation, particularly a concentration-crystallization operation is effective as a means for separating and recovering high-purity lithium sulfate directly from acid leaching. Still further, it has been found that a crystallization operation, particularly a cooling crystallization operation is effective as a means for preventing sodium from being mixed with lithium in the process of separating and recovering transition metals as sulfates.

Furthermore, by applying a two-stage crystallization process that combines these concentration-crystallization and cooling crystallization, it is possible to realize a separation and recovery process that satisfies the required quality and efficiency for each of lithium sulfate and transition metal sulfate, and the present inventors have found the following findings.

The process disclosed by the present invention is to separate and recover lithium as lithium sulfate crystals by performing a concentration-crystallization operation on a sulfate aqueous solution containing lithium and transition metals such as nickel and cobalt as main components. In addition, the transition metal is separated and recovered as a sulfate by performing a cooling crystallization operation on the sulfate aqueous solution containing the transition metal and lithium as main components.

And these concentration-crystallization and cooling crystallization can be operated in combination. In this case, the concentration-crystallization mother liquor can be introduced into the cooling crystallization step, and the cooling crystallization mother liquor can also be introduced into the concentration-crystallization step, so that lithium sulfate and transition metal sulfate are continuously added. It can be separated and collected. The raw material aqueous solution derived from the acid leaching solution is introduced into any one of the processes depending on its properties and operated.

The transition metals targeted by the present invention are derived from lithium- and transition metal-containing aqueous solutions generated in the recycling process of lithium ion secondary batteries, and lithium- and transition metal-containing solutions generated as by-products in the manufacturing and recycling processes of various battery materials. Thus the transition metals include nickel, manganese, iron, cobalt, copper and zinc. Among them, nickel and cobalt which are used in increasing amounts as battery materials, are particularly important in terms of their value as reusable resources.

Thus a first aspect of the present invention is to provide a process for producing lithium sulfate comprising:
a step of concentration-crystallization to an aqueous solution comprising at least lithium sulfate and a transition metal sulfate as main components so as to obtain a slurry comprising lithium sulfate as a solid content, and
a step of solid-liquid separation of the slurry obtained in the step of concentration-crystallization so as to separate lithium crystals and a crystallization mother liquor.

A second aspect of the present invention is to provide a process for producing a transition metal sulfate comprising:
a step of cooling crystallization to an aqueous solution comprising at least lithium sulfate and a transition metal sulfate as main components so as to obtain a solid content of crystals comprising the transition metal sulfate, and
a step of separating the slurry obtained in the cooling crystallization step into solid and liquid so as to obtain a solid content of crystals comprising the transition metal sulfate and a crystallization mother liquor.

A third aspect of the present invention is to provide the process for producing lithium sulfate and a transition metal sulfate according to the above aspect 1 or 2, comprising an operation of introducing the crystallization mother liquor separated in the concentration-crystallization step into the cooling crystallization step.

A fourth aspect of the present invention is to provide the process for producing lithium sulfate and a transition metal sulfate according to the above aspect 1 or 2, comprising an operation of introducing the crystallization mother liquor separated in the cooling crystallization step into the concentration-crystallization step.

A fifth aspect of the present invention is to provide the process for producing lithium sulfate and a transition metal sulfate according to the above aspect 1 or 2, comprising:
an operation of introducing the crystallization mother liquor separated in the concentration-crystallization step into the cooling crystallization step and
an operation of introducing the crystallization mother liquor separated in the cooling crystallization step into the concentration-crystallization step.

A sixth aspect of the present invention is to provide the process for producing lithium sulfate according to any one of the above aspects 1 and 3 to 5, wherein the operating temperature in the concentration-crystallization step is 20° C. or higher.

A seventh aspect of the present invention is to provide the process for producing lithium sulfate and a transition metal sulfate according to any one of the above aspects 3 to 5, wherein the concentration-crystallization temperature and the cooling crystallization temperature are adjusted so that the difference between the saturated solubility of each solute in the concentration-crystallization operation and the saturated solubility of each solute in the cooling crystallization operation is 0.5 mol/kg or more in mass molarity.

### Advantageous Effects of Invention

Through the concentration-crystallization operation step according to the present invention, lithium is obtained as high-purity lithium sulfate crystals. Lithium sulfate recovered in this process can be further purified by performing a simple impurity removal treatment by a known technique, so as to attain a quality suitable for producing lithium hydroxide using an electrochemical membrane separation method.

Through the cooling crystallization operation according to the present invention, transition metals are obtained as sulfate crystals. The lithium content in this crystal is sufficiently reduced so that the crystal is a suitable form for use in precursor synthesis. In addition, since the amount of lithium mixed in sodium sulfate which is a by-product of precursor synthesis, can be sufficiently reduced, the economic value of sodium sulfate is not reduced so as to contribute to the improvement of the economic efficiency of the recycling process as a whole. Moreover, the transition metal sulfates with greatly reduced lithium content obtained in this process do not affect conventional precursor synthesis processes. That is, there is no need to change raw material preparation and synthesis process parameters in the precursor synthesis step, so as to contribute to improving the economic efficiency of the entire recycling step.

In the process of separating lithium sulfate and transition metal sulfate by applying the crystallization step according to the present invention, any acid and alkali are not consumed to generate new sodium sulfate. This not only reduces the costs associated with acids and alkalis, but also contributes to improving the economic efficiency of the entire recycling process because excess sodium sulfate is not generated.

In the two-stage crystallization method according to the present invention, one crystallization mother liquor can be used as a raw material for the other those, so valuable lithium and transition metals can be separated and recovered with high efficiency. That is, the loss of these valuables is very small, resulting in very high economic efficiency.

### BRIEF DESCRIPTION OF DRAWINGS

FIG. 1 is a flow diagram summarizing the flow of a conventional solvent extraction method.

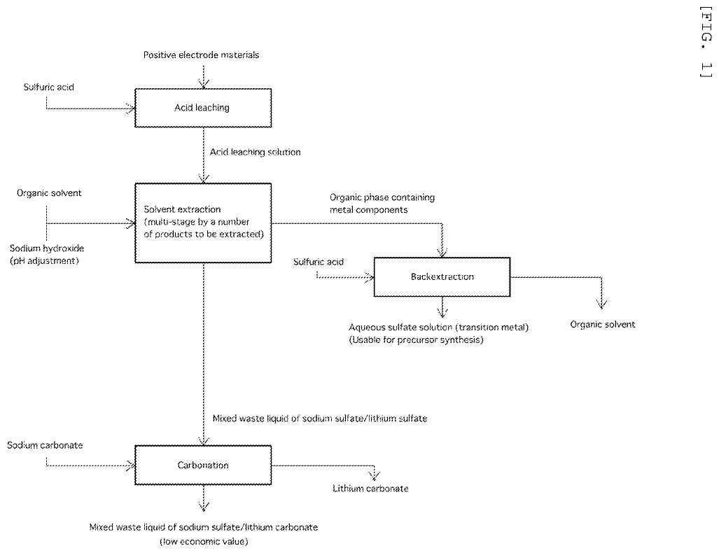

FIG. 2 is a flow diagram summarizing the flow of a conventional transition metal precipitation method.

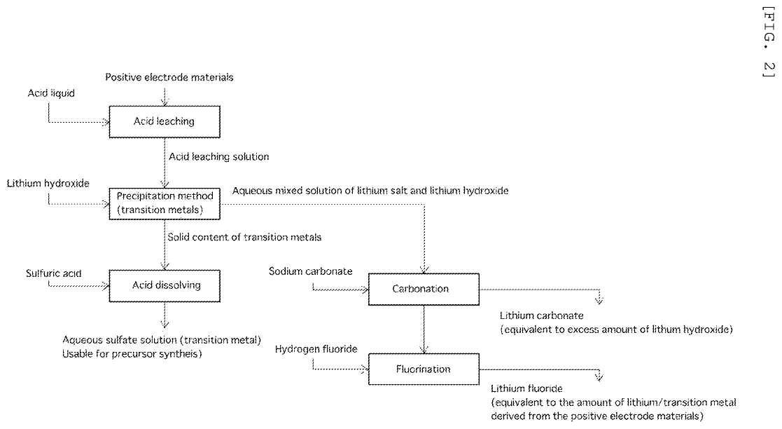

FIG. 3 is a flow diagram summarizing the flow of a conventional direct usage method.

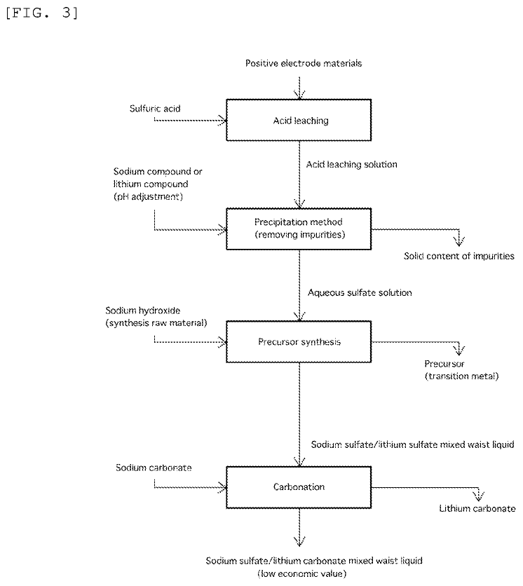

FIG. 4 is a flow diagram summarizing the relationship between an embodiment applying impurity removal by pH control as a pretreatment for two-step crystallization and an embodiment of precursor synthesis using thus obtained transition metal sulfate regarding the production of lithium sulfate and transition metal sulfate using the two-step crystallization of the present invention.

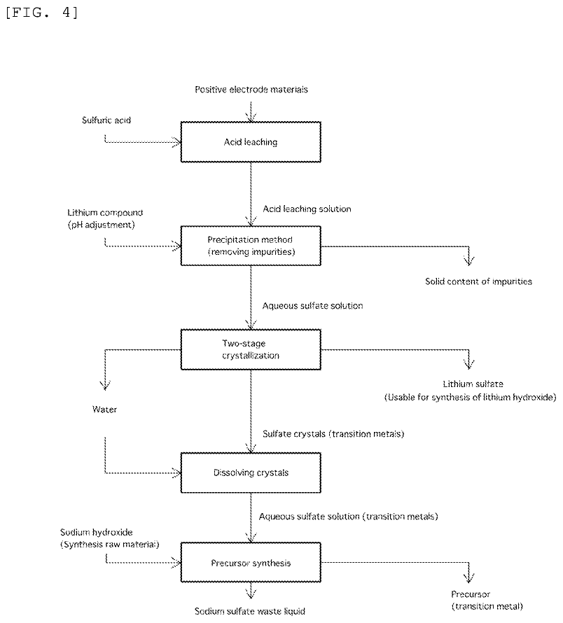

FIG. 5 is a flow diagram summarizing the flow of two-step crystallization of the present invention in a case where the composition of the raw material solution is lithium sulfate and nickel sulfate, and the concentration-crystallization is used as the raw material introduction part.

### DESCRIPTION OF EMBODIMENTS

In the following, possible embodiments according to the present invention will be described in more detail. However, these are merely examples of possible embodiments, and the combination of unit operations that constitute an actual step is not limited to these examples. Skilled person in the art can change these embodiments unless apart from the scope of the present invention.

The aqueous sulfate solution containing at least lithium sulfate and transition metal sulfate obtained by acid leaching may contain impurities such as Fe, Cu and Al. Such impurities can be removed in advance, if necessary. Impurity removal treatment using a lithium compound is suitable as the pretreatment for the two-step crystallization according to the present invention. In addition, when components remained as suspended components without being dissolved in the acid leaching step are mixed, they can be removed from the raw material aqueous solution using an appropriate solid-liquid separation device.

It is preferable to control the concentration of surplus sulfuric acid remaining in the leaching solution in the acid leaching process to be as low as possible. This is because if the excess sulfuric acid concentration increases, the solubility of the sulfate contained in the acid leaching solution and the tendency of the solubility change with respect to the operating temperature may change unfavorably. The surplus sulfuric acid concentration contained in the sulfate solution obtained through the acid leaching step is preferably 10% by weight or less, more preferably 5% by weight or less, still more preferably 1% by weight or less. The pH of the solution supplied to the crystallization operation is preferably controlled between 2 and 6 in order to maintain the solubility of the sulfate solution and the tendency of solubility change with respect to temperature operation at favorable conditions.

After the appropriate raw material aqueous solution is prepared in this way, the crystallization operation is carried out. Whether the raw material aqueous solution should be introduced to the concentration-crystallization step or the cooling crystallization step, depends on its composition. That is, when the raw material solution contains a larger amount of lithium sulfate, it is advantageous to perform the concentration-crystallization operation first. Conversely, if there is more transition metal sulfate in the raw material solution, it is advantageous to perform the cooling crystallization first. If the lithium/nickel ratio is more than 1, it is advantageous to introduce the raw material aqueous solution into a concentration-crystallization operated at temperature of 80° C. or higher. When the transition metal composition is complex, a small amount of raw material aqueous solution sample is concentrated at the operating temperature of concentration-crystallization, and when the crystals which start to precipitate first are lithium sulfate, it is preferable to introduce the raw material aqueous solution into concentration-crystallization.

The crystallization step may be carried out under continuous, batch-wise or semi-batch-wise type, but continuous operation is advantageous if the composition of the raw material solution is stable.

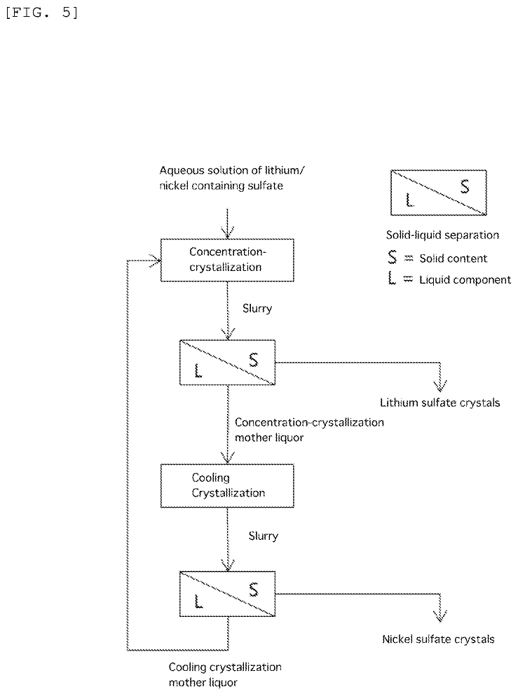

In the following, two-step crystallization is described along the flow diagram shown in FIG. 5 as an example in which the composition of the raw material solution is lithium sulfate and nickel sulfate and the raw material solution is introduced into the concentration-crystallization step.

First, in order to separate and recover lithium sulfate from the raw material solution, a concentration-crystallization operation is performed.

A concentration-crystallization operation is carried out by a known method using either heating or reduced pressure, or a combination of both. Since the solubility of lithium sulfate tends to decrease as the temperature rises, it is advantageous to carry out the concentration-crystallization operation in a high temperature range. However, to carry out it at too high temperature requires high cost of equipment, so that it is practically preferred to maintain the temperature range of 40 to 110° C., preferably 60° C. to 90° C.

Excessive concentration of the raw material solution accompanying the concentration-crystallization operation must be avoided. If the concentration proceeds excessively, the eutectic point composition is reached and the separation by crystallization becomes impossible (that is, the concentration must be carried out before reaching the eutectic point composition). The operable degree of concentration varies with the composition of raw material solution.

For example, when a raw material solution contains 1 mol/kg of lithium sulfate and 1 mol/kg of nickel sulfate as mass molar concentrations and a concentration-crystallization operation is performed to this raw material solution, lithium sulfate begins to precipitate when the concentration of lithium sulfate increases to about 2 mol/kg and the concentration of nickel sulfate increases to about 2 mol/kg. As the concentration proceeds further, the nickel sulfate concentration increases, but for example, if the operation is performed at 70° C., not only lithium sulfate but also nickel sulfate precipitates when the mass molar concentration of nickel sulfate exceeds about 3 mol/kg.

Therefore, after determining the composition of the raw material solution to be handled, the concentration operation is performed at the laboratory level, and the composition of the precipitate accompanying concentration is investigated. Thereby, it is preferable to investigate the concentration of lithium sulfate beginning to precipitate and the eutectic point which is impossible to separate by the crystallization operation in advance.

The solid content of the lithium sulfate crystals obtained by the concentration-crystallization operation is separated by a solid-liquid separator. A centrifugal separator is generally used as this device, but other types may also be used. In the solid-liquid separation step, the crystals are washed with water, warm water or an aqueous solution of lithium sulfate with high purity. This washing waste liquid can be directly returned to the concentration-crystallization step.

Next, a part of the concentration-crystallization mother liquor is extracted and subjected to a cooling crystallization operation by a known method. When the solution in which the concentration of solutes other than lithium has been increased by the concentration-crystallization operation is cooled, nickel sulfate precipitates as crystals due to the change in solubility.

The cooling crystallization operation is preferably carried out at a lower temperature, but if the set temperature is too low, the cooling cost tends to increase. Therefore, the temperature is generally maintained in the range of 5° C. to 60° C.

If the difference between the operating temperature for cooling crystallization and the operating temperature for concentration-crystallization is small, the efficiency of crystal precipitation in each step decreases. Therefore, it is preferable to set the difference of these operating temperatures to 30° C. or more, preferably 30° C. or more and 70° C. or less. For example, if the concentration-crystallization is operated at 70° C. and the cooling crystallization is operated at 35° C., the load of heating and cooling can be reduced.

It is known that the solubility of lithium sulfate decreases when it forms a mixed solution with transition metal sulfates. This property is in contrast to the fact that when the solubility of sodium sulfate forms a mixed solution with transition metal sulfates, it becomes more soluble in compositions that do not form double salts, that is, the solubility of sodium sulfate increases. In addition, the transition metal sulfate produced in the cooling crystallization operation tends to consume more solute water as water of crystallization than in the case of precipitation at a high temperature, so that concentration of the mother liquor proceeds together with the precipitation of transition metal sulfate. For this reason, in the mixed solution of sodium sulfate and transition metal sulfate, there is a high possibility that excessively dissolved sodium sulfate precipitates due to condensation accompanying the precipitation of the transition metal sulfate, whereas in the mixed solution of lithium sulfate, the solubility of lithium sulfate tends to increase with the precipitation of transition metal sulfate, so that the present invention can reduce the possibility that lithium sulfate will be mixed with the transition metal sulfate, and is featured by this disclosed cooling crystallization. That is, it becomes easier to obtain a higher-purity transition metal sulfate separated from lithium by the cooling crystallization.

The nickel sulfate crystals obtained by cooling crystallization are also washed by appropriate solid-liquid separation and washing equipment. A centrifugal separator is generally used, and a small amount of water, cold water, or a solution obtained by re-dissolving a part of the product crystals is used as a cleaning liquid. This cleaning waste liquid can be returned to the cooling crystallization step, but since the efficiency of the cooling crystallization is lowered, it is more operationally advantageous to return it to the concentration-crystallization step.

While continuing these operations, an appropriate amount of part of the cooling crystallization mother liquor is extracted and returned to the concentration crystallizer. Lithium sulfate remaining in the mother liquor is separated as crystals by a concentration-crystallization operation, and nickel sulfate is concentrated again.

Cooling crystallization may be carried out under reduced pressure under conditions able to evaporate water. Since the amount of heat corresponding to the latent heat of water is discharged outside the system by the evaporation, the cooling cost can be reduced. However, it should be avoided to excessively concentrate until such condition that lithium sulfate precipitates during cooling crystallization.

As the cooling crystallization, Eutectic Freeze Crystallization can also be used. When this technique is used, water crystals (ice) are produced as suspended matter in the process of obtaining transition metal crystals as precipitates, and by carrying out solid-liquid separation of these, the crystallization mother liquor can be concentrated at the same time. As long as lithium sulfate crystals are not precipitated during the cooling and crystallization operation, the vaporization energy required for concentration of the solution can be reduced as a whole system without departing from the aspect of the present invention.

Next, a case where the transition metal in the raw material solution comprising elements other than nickel is explained.

In this case, when performing cooling crystallization, the operating temperature range is selected so that the solubility of the transition metal sulfate decreases as the temperature decreases. The temperature at which concentration-crystallization is carried out is set higher than the operating temperature for cooling crystallization, and practically, the operating temperature for concentration-crystallization is preferably about 20° C. or higher. As the solute concentration increases, the freezing point drops, and cooling crystallization can be performed down to a temperature range of around −10° C. In view of temperature difference attaining an appropriate concentration difference at such low temperature range, a temperature difference of about 30° C. is required.

It should be noted that the appropriate temperature difference between the concentration-crystallization operation temperature and the cooling crystallization operation temperature varies depending on the composition of the raw material solution. In the case of a raw material solution comprising lithium sulfate and nickel sulfate as illustrated in FIG. 5, there is no problem in understanding that the difference in operating temperature between concentration-crystallization and cooling crystallization is proportional to the difference in saturated solubility of nickel sulfate.

On the other hand, for example, when the composition of the raw material solution comprises lithium sulfate, nickel sulfate and cobalt sulfate, a saturated solubility of cobalt sulfate is maximum at about 60° C., so that the operating temperature differences carrying out the two-stage crystallization cannot be treated as proportional to solubility differences. In this case, as a factor which determines the difference in the operating temperature, it is important that the difference in the saturated solubility of crystals obtained by cooling crystallization becomes a certain value or more due to the difference between the operating temperature for concentration-crystallization and the operating temperature for cooling crystallization.

The difference in this saturated solubility required for the two-step crystallization changes depending on the ratio of the amount of transition metal to lithium and the composition of the transition metal. But it is preferable to control the difference in operating temperature so as to attain at least a saturated solubility difference of 0.5 mol/kg or more as the mass molar concentration of the solute single substance for the transition metal sulfate.

In addition, for example, when two or more types of transition metals are contained in the raw material solution, such as a composition comprising lithium sulfate, nickel sulfate and cobalt sulfate, even though maintaining the above concentration difference as the operating temperature difference for the two-step crystallization, in the concentration-crystallization step, a sulfate such as cobalt sulfate whose solubility decreases on the high temperature side, may precipitate together with lithium sulfate. In such a case, it is possible to separate and recover lithium sulfate and cobalt sulfate by re-dissolving the lithium sulfate/cobalt sulfate precipitate obtained in the concentration-crystallization step and applying the two-step crystallization again to this aqueous solution.

That is, it should be understood that the embodiment of the present invention is not limited to one set of two-step crystallization, but also includes a form comprising multiple sets of two-step crystallization. Even if pure lithium sulfate cannot be separated in one set of two-step crystallization steps, the effect of the present invention can be realized by separating lithium sulfate and transition metal sulfate in the subsequent two-step crystallization step.

The concept of the impurity removal step related to the crystallization step according to the present invention is described below.

First, an acid leaching solution comprising lithium sulfate and nickel sulfate as main components is described as an example of the case where impurities are removed as a pretreatment for the crystallization operation.

As a method for removing impurities from a nickel sulfate aqueous solution, a precipitation method utilizing a solubility difference that accompanies pH changes is widely used. This technique is an effective means for major impurities expected in the acid leaching step such as Fe, Cu and Al, which are in the form of sulfates and have a precipitation pH lower than that of nickel.

Generally, sodium hydroxide is used for pH adjustment to remove impurities. However, when a large amount of sodium hydroxide is continuously used, the sodium mixed in the crystallization raw material solution is concentrated in the crystallization mother liquor, so that a sodium-nickel double salt or a sodium-lithium double salt is formed and these inhibit the separation by crystallization. In particular, the sodium-nickel double salt lowers the solubility of nickel in the concentration-crystallization mother liquor, causing a large amount of sodium and nickel to be mixed into the lithium sulfate.

Therefore, the amount of sodium mixed in the crystallization raw material solution must be kept low. Sodium mixed as a trace component is mixed in the crystals obtained by crystallization as a trace component, and this is discharged out of the crystallization system. When the amount of sodium mixed is a trace, the concentration level of sodium concentrated in the crystallization mother liquor can be kept below a certain level. As a guideline for the amount of sodium permissible in the crystallization process, the amount of elemental sodium is about 0.5 g or less per 1 kg of elemental nickel in the crystallization raw material solution, so that the amount of sodium mixed in the crystals obtained by crystallization is 100 ppm or less and it is possible to maintain the concentration of sodium in the mother liquor that does not affect the crystallization operation.

However, it is practically difficult to meet the required impurity removal amount with such a sodium usage amount. Therefore, lithium compounds, particularly lithium hydroxide are used in removing impurities from an aqueous solution containing lithium sulfate and nickel sulfate as main components by adjusting the pH. When the impurity dissolved as a sulfate reacts with lithium hydroxide to precipitate the impurity as a solid content, lithium sulfate derived from the impurity sulfate is dissolved in the solution. Since the raw material aqueous solution contains lithium sulfate, there is no problem even if lithium sulfate generated by the impurity removal operation using lithium hydroxide is added.

As pretreatment of the raw material aqueous solution to be supplied to the two-step crystallization, the major problem of impurities associated with the crystallization operation can be solved by providing a precipitation step using a lithium compound, especially lithium hydroxide, and a solid-liquid separation step for separating and removing this precipitate

Next, the concept of removing impurities in the post-treatment step is described.

If the crystallization step according to the present invention is applied, the removal of impurities may be carried out after separating and recovering lithium sulfate and transition metal sulfate from the raw material solution. And unlike the case where impurities are removed in the pretreatment step, it is not necessary to limit the chemical species used for removing impurities to lithium compounds. This is because the lithium is removed from the transition metal sulfate separated and recovered by the crystallization operation, so that it is possible to obtain the effect of avoiding the problem due to the mixing of sodium and lithium. Therefore, a known impurity removal method can be readily applied. For example, even when the pH adjustment method is used, not only a lithium compound such as lithium hydroxide, but also commonly used sodium hydroxide or the like can be used.

In order to maximize the effects of the present invention, it is optimal to carry out two-stage crystallization, that is concentration-crystallization and cooling crystallization are combined. The crystallization method disclosed by the present invention can also be partially utilized if it is judged not advantageous to apply the two-stage crystallization.

For example, the value of high-purity lithium sulfate may be recovered using only concentration-crystallization to obtain lithium sulfate, and the aqueous solution or crystals of transition metal sulfate with a reduced lithium content may be reused. When such a transition metal sulfate is used, a mixture of sodium and lithium may be generated. However, the separation and recovery of lithium sulfate can significantly reduce the amount of sodium-lithium mixture generated.

Alternatively, for example, the transition metal sulfate from which lithium has been removed using only cooling crystallization for obtaining the transition metal sulfate, is separated, recovered and reused, and lithium sulfate whose transition metal sulfate content has been greatly reduced, may be processed by known methods.

### Examples

Hereinafter, the present invention is described in more detail by showing examples relating to the crystallization step.

Analytical methods used in Examples are shown. The amount of transition metal sulfate contained in the raw material solution, crystallization mother liquor and transition metal sulfate crystals was measured by a known chelate titration method using a copper ion selective electrode. Also, the lithium content and the ratio of nickel and cobalt were measured by use of an ICP emission spectrometer iCAP6500 Duo (manufactured by Thermo Fisher Scientific Inc.).

### Example 1

<Separation and Recovery of Lithium Sulfate from Lithium Sulfate/Nickel Sulfate Aqueous Solution (Example of First Aspect)>

This Example shows that lithium sulfate can be separated and recovered from an aqueous sulfate solution comprising lithium sulfate and nickel sulfate by concentration-crystallization.

An aqueous solution of mixed lithium/nickel sulfate was prepared from reagents of nickel sulfate and lithium sulfate. The simulated mother liquor was made to contain nickel sulfate and lithium sulfate in an amount of 5.08% by weight in terms of metallic nickel and 1.23% by weight in terms of metallic lithium, respectively. The pH of this solution was 4.16 (measured at room temperature).

3.2 L of simulated mother liquor was added to a crystallization vessel with a heat insulating jacket. In order to heat this vessel, hot water adjusted to 90 to 93° C. was passed through the heat insulating jacket at a flow rate of 5.5 L/min. Furthermore, the absolute pressure in the crystallization vessel was controlled to between 35 and 38 kPa by continuously reducing the pressure during the concentration-crystallization so that the inside of the crystallization vessel was maintained at 80° C. Furthermore, the solution in the container was kept sufficiently stirred during the crystallization operation.

When the raw material solution with the same composition as the simulated mother liquor was continuously supplied to the crystallization vessel controlled in this way, crystals of lithium sulfate were generated after about 5.8 hours. A total of about 18 kg of raw material was supplied over 32 hours. After the crystals began to form, the slurry was intermittently extracted so that the solid content concentration in the container was constantly 12% by weight, and solid-liquid separation was carried out using a centrifuge. The solid content obtained by this operation was washed with a highly pure lithium sulfate aqueous solution. It was previously confirmed that the concentration at which the eutectic point was obtained under the above conditions at 80° C. was about 31% by weight as nickel sulfate in the mother liquor.

The analysis results of the lithium sulfate sample obtained by the concentration-crystallization operation are shown in Table 1.

TABLE 1

| | | Ni | Li |
|---|---|---|---|
| Example No. | Sample | [wt. %] | [wt. %] |
| Example 1 | Raw material solution for | 5.08 | 1.23 |
| | concentration-crystallization | | |
| | Lithium sulfate crystals | 0.0186 | 10.5 |
| | Concentration-crystallization | 11.4 | 1.15 |
| | mother liquor (at sampling of | | |
| | above crystals) | | |
| Example 2 | Nickel sulfate crystals | 22.4 | 0.0088 |
| | Mother liquor after cooling | 7.4 | 1.85 |
| | crystallization | | |

As seen from Table 1, it can be understood that lithium sulfate crystals with high purity are obtained as a result of separating lithium from nickel.

### Example 2

<Separation and recovery of nickel sulfate from concentration-crystallization mother liquor (Example of second aspect)>

The liquid component of the concentration-crystallization mother liquor obtained in Example 1 was recovered by solid-liquid separation. In addition, thus obtained liquid component was combined with the liquid component obtained by the intermittent extraction operation during the concentration-crystallization operation in Example 1 and transferred to a vessel kept at 80° C. and this was used as a raw material solution for cooling crystallization.

A solution having the same composition of the simulated mother liquor used in the concentration-crystallization was concentrated 1.52 times and used as the starting mother liquor for cooling crystallization. 3.1 L of this concentrated liquid was added into the crystallization vessel. The temperature of the cooling water flowing through the heat insulating jacket was controlled so that the inside of the vessel was maintained at 25° C. during cooling crystallization.

When the raw material solution for cooling crystallization was continuously supplied, crystals of nickel sulfate were precipitated. The raw material for cooling crystallization was continuously supplied over about 17 hours. During the cooling crystallization operation, the slurry was intermittently withdrawn so that the amount of the slurry liquid in the crystallization vessel remained substantially constant. Solid-liquid separation of the extracted slurry was carried out using a centrifugal separator, and the solid content obtained by this operation was washed with a high-purity nickel sulfate aqueous solution.

The analysis results of the nickel sulfate sample obtained by the cooling crystallization operation are shown in Table 1.

As seen from Table 1, it can be understood that as a result of separating nickel and lithium, high-purity nickel sulfate with a significantly reduced lithium concentration is obtained.

From the results of Examples 1 and 2 shown in Table 1, nickel sulfate and lithium sulfate are concentrated by the concentration-crystallization operation, but since lithium sulfate precipitates as crystals, Table 1 shows that the lithium ratio in the concentration-crystallization mother liquor decreases. Since the cooling crystallization mother liquor has the same nickel/lithium ratio as the raw material solution supplied to the concentration-crystallization, it can be understood that the cooling crystallization mother liquor can be returned to the concentration-crystallization step as it is, and can be used repeatedly for concentration-crystallization so as to obtain lithium sulfate crystals.

### Example 3

An aqueous solution comprising 16.4% by weight of lithium sulfate and 30.5% by weight of cobalt sulfate (Li/Co molar ratio=1.51) was prepared and kept at 60° C. When the solution was cooled to 4° C., crystals were precipitated.

To the obtained slurry, solid-liquid separation was carried out by vacuum filtration using Buchner funnel and filter paper No. 5C (90 mm diameter, manufactured by Advantech Co., Ltd). The crystals were further washed using water. The amounts of lithium and cobalt contained in the obtained crystals were analyzed by an ICP emission spectrometer, the molar ratio of lithium and cobalt Li/Co was 0.036.

### Example 4

A solution comprising 10.9% by weight of lithium sulfate, 15.7% by weight of nickel sulfate and 20.8% by weight of cobalt sulfate (Li/(Ni+Co) molar ratio=0.84) was prepared and kept at 60° C. When this solution was cooled to 4° C., crystals were precipitated.

Solid-liquid separation, washing and analysis of the crystals contained in the obtained slurry were carried out in the same manner as in Example 3, and the molar ratio Li/(Ni+Co) of lithium to cobalt and nickel was 0.012.

As is clear from the results of Examples 2 to 4, transition metal sulfates can be separated and recovered from lithium sulfate/nickel sulfate solutions, lithium sulfate/cobalt sulfate solutions and lithium sulfate/nickel sulfate/cobalt sulfate solutions by cooling crystallization.

### Example 5

A solution comprising 12.2% by weight of lithium sulfate, 5.90% by weight of nickel sulfate and 19.7% by weight of cobalt sulfate (Li/(Ni+Co) molar ratio=1.35) was prepared and kept at 80° C. This solution was kept at 80° C. while being stirred by a stirrer. When the volume was concentrated to about 4/5 and sampling was performed, white crystals were precipitated. Further concentration was carried out until the volume became about 3/5, and a mixture of white crystals and purple crystals was precipitated.

Crystals contained in the finally obtained slurry were subjected to solid-liquid separation, washing and analysis in the same manner as in Example 3, and the molar ratio Li:Ni:Co: of lithium, nickel and cobalt was 99.6:0.1:0.3.

Also, when the mother liquor obtained by the solid-liquid separation operation was cooled to 15° C., crystals precipitated.

Solid-liquid separation, washing and analysis of the crystals contained in the slurry obtained by the cooling crystallization operation were carried out in the same manner as in Example 3. As a result, the obtained crystal had the lithium content below the detection limit and comprised nickel and cobalt as the main components.

Lithium sulfate crystals were separated by the concentration-crystallization operation, but as a result of further concentration, it is clear that nickel and cobalt were mixed in as colored crystals. Since the total concentration of nickel sulfate and cobalt sulfate was 35.5% by weight in the finally obtained concentration-crystallization mother liquor, the eutectic point in this composition was 35% by weight as the total concentration of nickel sulfate and cobalt sulfate. Therefore, in this case, the concentration-crystallization operation should be carried out under the condition that the total concentration of nickel sulfate and cobalt sulfate in the mother liquor is less than 35% by weight. By such a procedure, the practically operable concentration range can be confirmed.

### Comparative Example 1

The quality of an aqueous sodium sulfate solution and lithium carbonate crystals obtained by adding sodium carbonate to a mixed aqueous solution of lithium sulfate and sodium sulfate was investigated.

A raw material aqueous solution was prepared from lithium sulfate and sodium sulfate reagents. Reagents were dissolved in such a manner that 7.89% by weight of lithium sulfate and 20.4% by weight of sodium sulfate were contained, respectively to prepare 697 g of raw material aqueous solution.

This raw material aqueous solution was transferred to a 1 L stainless steel container, and while stirring with a stirrer and maintaining the solution temperature at 55° C., 169 g of a 32.9 wt % sodium carbonate aqueous solution was added over 30 minutes. After the addition, stirring and heat retention were maintained for 3 hours, and solid-liquid separation was carried out.

To the obtained slurry, solid-liquid separation was carried out by vacuum filtration using Buchner funnel and filter paper No. 5C (90 mm diameter, manufactured by Advantech Co., Ltd). The solid cake was washed with warm water heated to about 35° C. and then dried in a dryer maintained at 60° C.

When the filtrate obtained by solid-liquid separation of the slurry was analyzed by an ICP emission spectrometer, the molar ratio of dissolved lithium and sodium was Na:Li=93:7. Moreover, 4493 ppm of sodium was mixed in the obtained solid content. Assuming that the solid content was lithium carbonate, its purity was measured by a known acid-base titration method and the purity was 97.0%.

From the above, since a large amount of lithium was mixed in the liquid component after recovering lithium carbonate by adding sodium carbonate, the economic value of sodium sulfate is lost. Also, for the quality of lithium carbonate recovered as a solid content, it was significantly contaminated by alkali metals such as sodium, it is necessary to purify it again to use it as a lithium raw material. Therefore, it is clear to require an improvement for reuse.

### INDUSTRIAL APPLICABILITY

The process for producing lithium sulfate and transition metal sulfate according to the present invention efficiently separates and recovers a mixed solution obtained as an acid leaching solution using a conventional apparatus, and as a form of utilization, it satisfies the quality that meets the requirements of the post-process. Therefore, it enables extremely economical reuse.

1. A process for producing lithium sulfate comprising:
a step of concentration-crystallization to an aqueous solution comprising at least lithium sulfate and a transition metal sulfate as main components so as to obtain a slurry comprising lithium sulfate as a solid content, and
a step of solid-liquid separation of the slurry obtained in the step of concentration-crystallization so as to separate lithium crystals and a crystallization mother liquor.

2. A process for producing a transition metal sulfate comprising:
a step of cooling crystallization to an aqueous solution comprising at least lithium sulfate and a transition metal sulfate as main components so as to obtain a solid content of crystals comprising the transition metal sulfate, and
a step of separating the slurry obtained in the cooling crystallization step into solid and liquid so as to obtain a solid content of crystals comprising the transition metal sulfate and a crystallization mother liquor.

3. The process for producing lithium sulfate and a transition metal sulfate according to claim 1, comprising an operation of introducing the crystallization mother liquor separated in the concentration-crystallization step into the cooling crystallization step.

4. The process for producing lithium sulfate and a transition metal sulfate according to claim 1, comprising an operation of introducing the crystallization mother liquor separated in the cooling crystallization step into the concentration-crystallization step.

5. The process for producing lithium sulfate and a transition metal sulfate according to claim 1, comprising:
an operation of introducing the crystallization mother liquor separated in the concentration-crystallization step into the cooling crystallization step and
an operation of introducing the crystallization mother liquor separated in the cooling crystallization step into the concentration-crystallization step.

6. The process for producing lithium sulfate according claim 1, wherein the operating temperature in the concentration-crystallization step is 20° C. or higher.

7. The process for producing lithium sulfate and a transition metal sulfate according to claim 3, wherein the concentration-crystallization temperature and the cooling crystallization temperature are adjusted so that the difference between the saturated solubility of each solute in the concentration-crystallization operation and the saturated solubility of each solute in the cooling crystallization operation is 0.5 mol/kg or more in mass molarity.
